(19) United States
(12) Patent Application Publication
(10) Pub. No.: US 2026/0291312 A1
(43) Pub. Date: Sep. 24, 2026

(54) Rotor and Electric Motor

(71) Applicant: AAC Microtech (Changzhou) Co., Ltd., Changzhou City (CN)

(72) Inventors: Xiangxi Chen, Changzhou (CN); Shun Guo, Changzhou (CN)

(21) Appl. No.: 19/315,799

(22) Filed: Sep. 1, 2025

Related U.S. Application Data
(63) Continuation of application No. PCT/CN2025/084172, filed on Mar. 21, 2025.

(51) Int. Cl. H02K 1/28; H02K 1/278

(52) U.S. Cl. CPC H02K 1/28; H02K 1/278

(57) ABSTRACT

A rotor and an electric motor are disclosed. The rotor includes a rotary shaft, a rotor core, a securing piece, a magnet; the rotor core is provided with a through hole running therethrough; the rotary shaft passes through the through hole and is secured to the rotor core; a plurality of snap-in slots extending through a thickness direction of the rotor core are formed on an outer side surface of the rotor core; the securing piece includes a snap portion fitted in the snap-in slot and a securing portion extending along the snap portion to protrude from the outer side surface of the rotor core; the magnet is held between the securing portions of adjacent two securing pieces. The securing piece, when being heated, does not impose an axial force against the silicon steel sheets at the two ends of the rotor core and thusly does not get loosened.

### FIELD

The subject matter described herein relates to rotor technologies, and more particularly relates to a rotor and an electric motor.

### BACKGROUND

An electric motor comprises a rotor and a stator; the rotor and the stator work in tandem to convert electrical energy into mechanical energy or vice versa. The rotor comprises a rotor core and a magnet, the rotor core being made of a plurality of of steel sheets stacked together, a plurality of groves being distributed along a peripheral side of the rotor core, a magnet securing piece being correspondingly arranged in each groove, the magnet being disposed between adjacent two magnet securing pieces.

In conventional technologies, a retainer ring connected to the plurality of magnet securing pieces is arranged at one end of the rotor core in a thickness direction of the rotor core so as to enhance connection secureness between the magnet securing pieces and the rotor core; however, arrangement of the retainer ring limits that the magnet can only be mounted from the side of the rotor core opposite the retainer ring, which reduces mounting flexibility of the magnet; in addition, the plastic retainer ring hampers heat dissipation of the magnet in the axial direction, which degrades thermal capacity of the electric motor. In other conventional technologies, a non-grooved cladding steel sheet is provided at two ends of the rotor core in the thickness direction of the rotor core, respectively, to prevent the magnet securing piece between the cladding steel sheets at two ends of the rotor core from getting loosened from the two ends of the rotor core; however, if the magnet securing piece is heated to expand in the axial direction of the rotor core, the cladding steel sheet would receive an axial force imposed from the two ends of the magnet securing piece, which might cause loosening of the cladding steel sheet affecting normal operation of the rotor core.

Therefore, it is desirable to provide a rotor to address the issues noted supra.

### SUMMARY

To overcome the drawbacks noted supra, a rotor and an electric motor are provided herein, which can improve mounting flexibility of magnets and prevent loosening of steel sheets at two ends of a rotor core.

In a first aspect, the present disclosure provides a rotor, comprising:
a rotary shaft;
a rotor core provided thereon with a through hole running therethrough, the rotor core being made of a plurality of silicon steel sheets stacked together, the rotary shaft passing through the through hole and being secured to the rotor core, an outer side surface of the rotor core being inwardly recessed to form a plurality of snap-in slots that are distributed at intervals and extend through a thickness direction of the rotor core;
a securing piece comprising a snap portion fitted in the snap-in slot and a securing portion extending along the snap portion to protrude from the outer side surface of the rotor core, a count of the securing pieces being equal to that of the snap-in slots, the snap portions and the snap-in slots corresponding in a one-to-one manner to form a tight projection-slot fitting, two ends of the securing piece, when being heated, being extendable in the thickness direction of the rotor core till an outer portions of the snap-in slot, respectively;
a magnet held between the securing portions of adjacent two securing pieces.

Optionally, the rotor core is made of a plurality of first silicon steel sheets and at least one second silicon steel sheet stacked together, an outer surface of the first silicon steel sheet being inwardly recessed to form a plurality of first notches distributed at intervals, an outer surface of the second silicon steel sheet being inwardly recessed to form a plurality of second notches distributed at intervals, a count of the first notches being equal to that of the second notches, the first notches and the second notches being arranged in one-to-one correspondence to form the snap-in slot, the snap portion being fitted with the first notch in a protrusion-recess manner, the snap portion being fitted with the second notch in a protrusion-recess manner.

Optionally, a depth of the first notch is greater than that of the second notch.

Optionally, a width of the first notch is greater than that of the second notch.

Optionally, the first notch has a bottom end and an opening end which are oppositely set, a width of the bottom end of the first notch being greater than that of the opening end of the first notch.

Optionally, the first notch comprises a tapered section and a rectangular section, a width of the tapered section being gradually shrunk in a direction away from a center of the rotor core, one end of the rectangular section distant from the center of the rotor core communicating with one end of the tapered section distant from the center of the rotor core, the end of the rectangular section distant from the center of the rotor core and the end of the tapered section distant from the center of the rotor core extending till an edge of the first silicon steel sheet to form the opening end.

Optionally, an outer side surface of the snap portion is inwardly recessed to form a groove, the groove being fitted with one of the at least one second silicon steel sheetin a protrusion-recess manner.

Optionally, the groove is formed by an outer side surface of the snap portion inwardly recessed in a direction from the center of the rotor core till an edge of the rotor core; and/or, the groove is formed by the outer side surface of the snap portion inwardly recessed in a circumferential direction of the rotor core.

Optionally, the second silicon steel sheet is held between adjacent two of the first silicon steel sheets.

In a second aspect, the present disclosure provides an electric motor, the electric motor comprising a rotor noted supra.

In the rotor and the electric motor according to some implementations of the present disclosure, the rotor comprises a rotary shaft, a rotor core, a securing piece, and a magnet; the rotor core is provided thereon with a through hole running therethrough, the rotary shaft passes through the through hole and is secured to the rotor core, and a plurality of snap-in slots extending through a thickness direction of the rotor core are formed at a peripheral side of the rotor core made of a plurality of silicon steel sheets stacked together; the securing piece comprises a snap portion fitted in the snap-in slot and a securing portion extending along the snap portion and protruding from the outer side surface of the rotor core; the protrusion-slot fitting between each snap-in slot and one corresponding securing piece enables the securing piece to be securely fitted in the snap-in slot of the rotor core, which ensures connection reliability between the securing piece and the snap-in slot. The magnet is held between the securing portions of two adjacent securing pieces; the connection reliability between the snap portion and the snap-in slot may ensure the connection reliability between the magnet and the securing piece. The rotor core comprises an upper surface and a lower surface, the upper surface and the lower surface being spaced apart in the thickness direction of the rotor core; in addition, the two ends of the securing piece in the thickness direction of the rotor core are flush with the upper surface and the lower surface, respectively. Since the two ends of the securing piece extend towards the two ends of the snap-in slot till the upper surface and the lower surface of the rotor core in the thickness direction of the rotor core, the securing piece, when being heated, does not impose an axial force against the silicon steel sheets at the two ends of the rotor core, so that the silicon steel sheets at the two ends of the rotor core would not get loosened, which enhances secureness and reliability of the rotor core and ensures normal operation of the rotor core. In this implementation, since no plastic retainer ring is provided at either end of the rotor core, the magnet can be mounted between two adjacent securing pieces from any end of the rotor core, whereby mounting flexibility of the magnet is enhanced compared with conventional technologies. In addition, since no retainer ring is provided, axial heat dissipation of the magnet may be enhanced, and thermal capacity of the rotor and the electric motor may also be enhanced.

### BRIEF DESCRIPTION OF THE DRAWINGS

To illustrate the technical solutions in the embodiments of the disclosure more clearly, the drawings referred to in describing the embodiments will be introduced briefly. It is apparent that the drawings provided below are only some embodiments of the disclosure, and to those skilled in the art, other drawings may also be derived based on these drawings without exercise of inventive work, in which:

FIG. 1 is an overall structural assembly axonometric diagram of a rotor according to some implementations of the present disclosure;

FIG. 2 is a partial structural schematic view of the rotor shown in FIG. 1;

FIG. 3 is a partial structural sectional view of the rotor shown in FIG. 2;

FIG. 4 is an assembly axonometric diagram between a rotor core and a securing piece shown in FIG. 1;

FIG. 5 is an overall structural axonometric diagram of the rotor core shown in FIG. 1;

FIG. 6 is a partial structural axonometric diagram of the rotor core shown in FIG. 5;

FIG. 7 is a front view of the rotor core shown in FIG. 5;

FIG. 8 is a front view of a first silicon steel sheet shown in FIG. 7;

FIG. 9 is an axonometric diagram of the securing piece shown in FIG. 1.

### DETAILED DESCRIPTION OF EMBODIMENTS

To make the objectives, technical solutions, and advantages more apparent, various implementations of the present disclosure will be described in detail with reference to the accompanying drawings. A person of normal skill in the art would appreciate that, in various implementations of the present disclosure, many technical details are provided for facilitating readers to understand the present disclosure; however, even without such details, the technical solutions sought for protection in the present disclosure may also be implemented based on alterations and modifications made to the implementations.

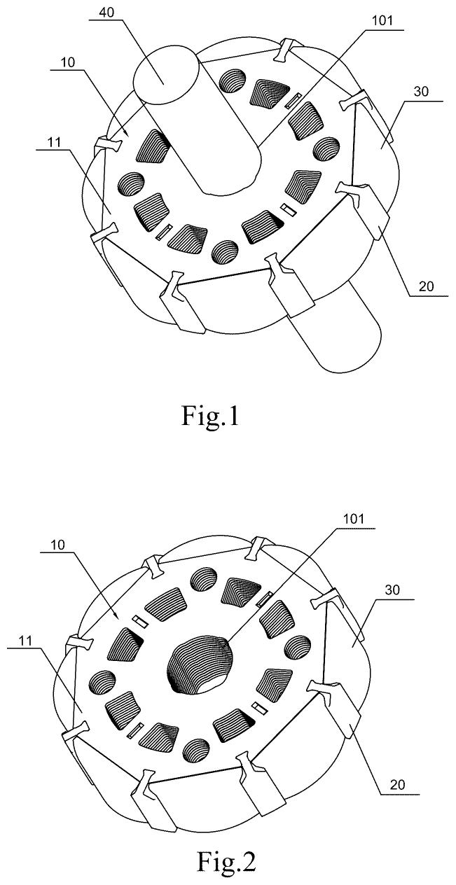

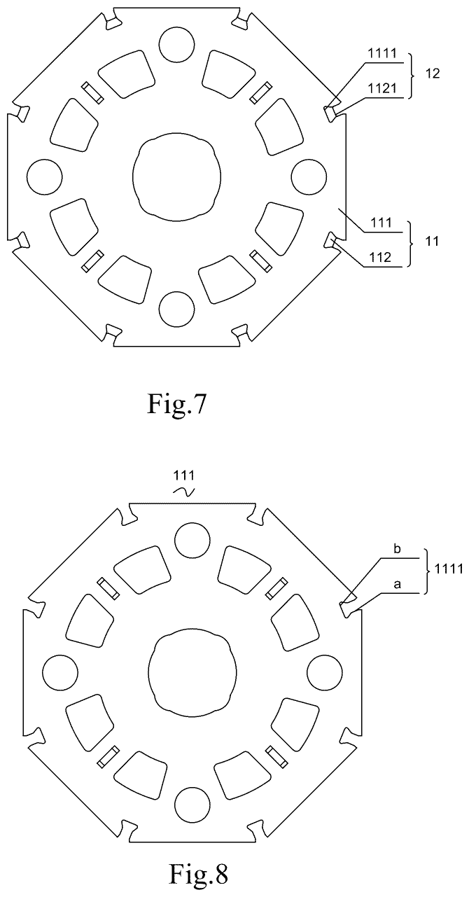

Referring to FIGS. 1 to 9, a technical solution of the present disclosure provides a rotor 100, the rotor 100 comprising: a rotor core 10, a securing piece 20, a magnet 30, and a rotary shaft 40; specifically, the rotor core 10 is provided thereon with a through hole 101 running therethrough, the rotary shaft 40 passes through the through hole 101 and is secured to the rotor core 10; the rotor core 10 is made of a plurality of silicon steel sheets 11 stacked together, and an outer side surface of the rotor core 10 is inwardly recessed to form a plurality of snap-in slots 12 distributed at intervals and extending through a thickness direction of the rotor core 10; the securing piece 20 comprises a snap portion 21 fitted in the snap-in slot 12 and a securing portion 22 extending along the snap portion 21 to protrude from the outer side surface of the rotor core 10, a count of the securing pieces 20 being equal to that of the snap-in slots 12; the rotor core 10 comprises an upper surface and a lower surface which are oppositely set and spaced apart in the thickness direction; two ends of the securing piece 20 in the thickness direction are flush with the upper surface and the lower surface, respectively; the magnet 30 is held between the securing portions 22 of adjacent two securing pieces 20.

The rotor 100 according to an implementation of the present disclosure comprises a rotor core 10, a securing piece 20, a magnet 30, and a rotary shaft 40; the rotor core 10 is provided thereon with a through hole 101 running therethrough; the rotary shaft 40 passes through the through hole 101 and is secured to the rotor core 10; a plurality of snap-in slots 12 extending through a thickness direction of the rotor core 10 are formed at a peripheral side of the rotor core 10 made of a plurality of silicon steel sheets 11 stacked together. The securing piece 20 comprises a snap portion 21 fitted in the snap-in slot 12 and a securing portion 22 extending along the snap portion 21 and protruding from the outer side surface of the rotor core 10. By forming a protrusion-groove fitting between each snap-in slot 12 and the snap portion 21 of one corresponding securing piece 20, the securing piece 20 is securely connected in the snap-in slot 12 of the rotor core 10, which ensures connection reliability between the securing piece 20 and the snap-in slot 12. The magnet 30 is held between the securing portions 22 of adjacent two securing pieces 20; the connection reliability between the snap portion 21 and the snap-in slot 12 may ensure the connection reliability between the magnet 30 and the securing piece 20. The rotor core 10 comprises an upper surface and a lower surface, the upper surface and the lower surface being arranged at an interval in the thickness direction of the rotor core 10; two ends of the securing piece 20 in the thickness direction of the rotor core 10 are flush with the upper surface and the lower surface, respectively. Since the two ends of the securing piece 20 extend along the thickness of the rotor core 10 towards the two ends of the snap-in slot 12 till an outer portion of the upper surface and an outer portion of the lower surface of the rotor core 10, respectively, the securing piece 20, when being heated, does not impose an axial force against the silicon steel sheets 11 at the two ends of the rotor core 10, so that the silicon steel sheets 11 at the two ends of the rotor core 10 would not get loosened; in this way, the secureness and reliability of the rotor core 10 is enhanced, ensuring normal operation of the rotor core 10. In this implementation, neither of the two ends of the rotor core 10 is arranged with a plastic retainer ring so that the magnet 30 may be mounted between adjacent two securing pieces 20 from any end of the rotor core 10, which enhances mounting flexibility of the magnet 30 compared with conventional technologies; in addition, without arrangement of the retainer ring, the axial heat dissipation of the magnet 30 may be improved, thereby enhancing thermal capacity of the rotor 100 and the electric motor.

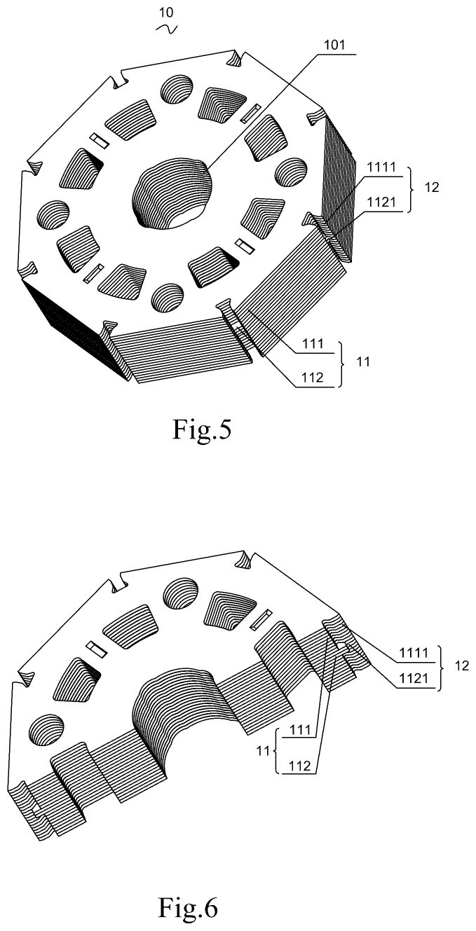

Optionally, as illustrated in FIGS. 5 to 7, the rotor core 10 is made of a plurality of first silicon steel sheets 111 and at least one second silicon steel sheet 112 stacked together; an outer side surface of the first silicon steel sheet 111 is inwardly recessed to form a plurality of first notches 1111 distributed at intervals, and an outer side surface of the second silicon steel sheet 112 is inwardly recessed to form a plurality of second notches 1121 distributed at intervals, a count of the first notches 1111 being equal to that of the second notches 1121; in addition, the first notches 1111 and the second notches 1121 are arranged in one-to-one correspondence to form the snap-in slot 12 running through the thickness direction of the rotor core 10, i.e., the count of the snap-in slots 12 is equal to that of the first notches 1111 and that of the second notches 1121. When the securing piece 20 is tightly fitted in the corresponding snap-in slot 12 in a protrusion-slot manner, the snap portion 21 of the securing piece 20 inserted in the first notch 111 has a shape in agreement with the first notch 1111, i.e., the securing piece 20 is fitted in the first notch 1111 via the snap portion 21 in a protrusion-slot manner, and the snap portion 21 of the securing piece 20 is fitted in the second notch 1121 in a protrusion-slot manner. The protrusion-slot fitting between the securing piece 20 and the snap-in slot 12 via the first notch 1111 and the second notch 1121 prevents the securing piece 20 from migrating out of the snap-in slot 12, thereby enhancing connection secureness and reliability between the securing piece 20 and the snap-in slot 12.

Optionally, a depth of the first notch 1111 is greater than that of the second notch 1121. When the securing piece 20 is fitted in the snap-in slot 12, a portion of the securing piece 20 is rested in the first notch 1111, which portion being shaped and sized to match the first notch 1111, whereby the securing piece 20 is fitted in the notch 1111 in a protrusion-slot manner. Since the depth of the second notch 1121 is less than that of the second notch 1121, the second notch 1121 abuts against the securing piece 20 in the radial direction of the rotor core 10, resulting in tight fitting between the securing piece 20 and the snap-in slot 12. In this implementation, it is preferable that the depth of the first notch 1111 is greater than that of the second notch 1121.

In an alternative implementation, a width of the first notch 1111 is greater than that of the second notch 1121. To fit the securing piece 20 into the snap-in slot 12, a portion of the securing piece 20 is rested in the first notch 1111, which portion being shaped and sized to match the first notch 1111, whereby a protrusion-slot fitting is formed between the securing piece 20 and the first notch 1111. Since the width of the second notch 1121 is less than that of the first notch 1111, the second notch 1121 abuts against the securing piece 20 in the circumferential direction of the rotor core 10, whereby the securing piece 20 is tightly fitted in the snap-in slot 12.

Optionally, the first notch 1111 has a bottom end and an opening end which are oppositely set, a width of the bottom end of the first notch 1111 being greater than that of the opening end of the first notch 1111. The bottom end of the first notch 1111 is proximal to a center of the rotor core 10, and the opening end of the first notch 111 is distant from the center of the rotor core 10, i.e., the width of the bottom end of the first notch 1111 proximal to the rotor core 10 is greater than that of the opening end of the first notch 1111 distant from the rotor core 10. Correspondingly, the shape of the portion of the securing piece 20 inserted in the first notch 1111 agrees with that of the first notch 1111, and the size of the portion of the securing piece 20 inserted in the first notch 1111 agrees with that of the first notch 1111. By setting the width of the bottom end of the first notch 1111 to be greater than that of its opening end, the securing piece 20 does not migrate out of the the first notch 1111 in the radial direction of the rotor core 10, which realizes protrusion-slot fitting between the securing piece 20 and the first notch 1111 and thusly ensures connection reliability between the first notch 1111 and the securing piece 20.

Optionally, as illustrated in FIG. 8, the first notch 1111 comprises a tapered section a and a rectangular section b, a width of the tapered section a being gradually shrunk in a direction away from the center of the rotor core 10, the rectangular section b communicating with the end of the tapered section a distant from the center of the rotor core 10, i.e., the rectangular section b communicates with the narrower end of the tapered section a and extends till the edge of the first silicon steel sheet 111 to form the opening end. By setting the width of the rectangular section b smaller than or equal to the width of the end of the rectangular section b distant from the center of the rotor core 10, it is ensured that the width of the bottom end of the first notch 1111 is greater than that of the opening end of the first notch 1111.

Correspondingly, the second notch 1121 has a rectangular shape, the size of the second notch 1121 agrees with that the rectangular section b of the first notch 1111, and the second notch 1121 is positioned corresponding to the rectangular section b of the first notch 1111.

Optionally, at least one of the second silicon steel sheets 112 is disposed between a plurality of the first silicon steel sheets 111, i.e., neither of the two ends of the rotor core 10 is provided with the second silicon steel sheet 112, which facilitates mounting of the securing piece 20.

Optionally, at least one second silicon steel sheet 112 is disposed in a middle portion of the rotor core 10; when the securing piece 20 is mounted in the snap-in slot 12, the at least one second silicon steel sheet 112 abuts against the middle portion of the securing piece 20 so that the securing piece 20 receives a force in its middle portion, which ensures that the two ends of the securing piece 20 are equally spaced from the outer wall of the rotor core 10, thereby facilitating mounting of the magnet 30.

Optionally, at least two second silicon steel sheets 112 are adjacently disposed, i.e., at least two second notches 1121 are correspondingly adjacent, and the securing piece 20 abuts against the at least two adjacent second notches 1121, which may prevent the securing piece 20 from receiving a concentrated stress; meanwhile, the bottoms of the at least two adjacent second notches 1121 may share the action force imposed by the securing piece 20, which prevents a damage to a single second steel sheet 112 that receives a large stress. In this implementation, the two second silicon steel sheets 112 are adjacently arranged, i.e., the two second notches 1121 are correspondingly adjacent; by setting two second silicon steel sheets 112 in adjacency, it may prevent the securing piece 20 from being subjected to a concentrated stress, thereby reducing the stress applied to a single silicon steel sheet 11.

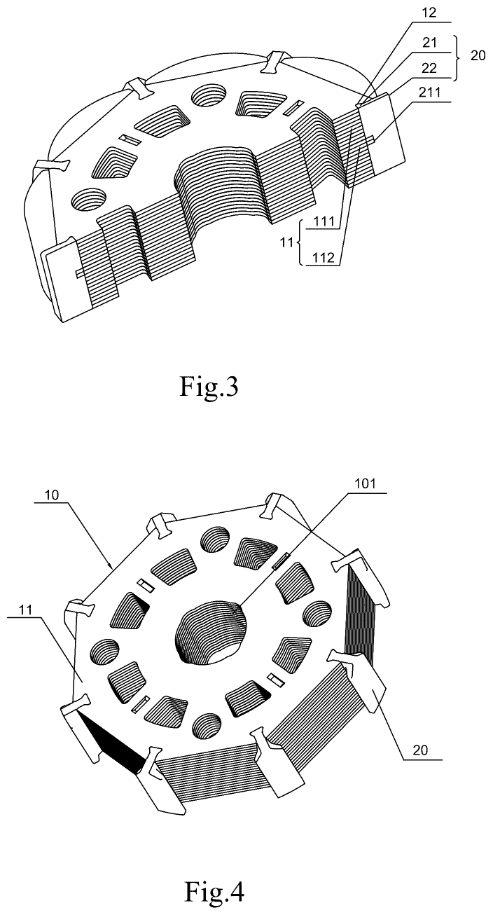

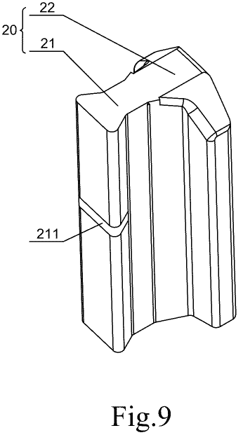

Optionally, as illustrated in FIGS. 3 and 9, the outer side surface of the snap portion 21 is inwardly recessed to form a groove 211; the groove 211 is fitted with the second silicon steel sheet 112 in a protrusion-slot manner; with the fitting between the outer side surface of the snap portion 21 and the first notch 1111 and the fitting between the groove 211 of the snap portion 21 and the second silicon steel sheet 112, protrusion-slot fitting between the securing piece 20 and the snap-in slot 12 is realized.

Optionally, the groove 211 may be formed by the inwardly recessed outer side surface the snap portion 21 along a direction from the center of the rotor core 10 to the edge of the rotor core 10; or, the groove 211 may be formed by the inwardly outer side surface of the snap portion 21 along the circumferential direction of the rotor core 10; or, the groove 211 may be formed by the inwardly recessed outer side surface of the snap portion 21 in the direction from the center to the edge of the rotor core 10 and in the circumferential direction of the rotor core 10.

In a second aspect, the present disclosure provides an electric motor, comprising the rotor 100 described supra.

The electric motor according to this implementation of the present disclosure comprises a rotor 100, the rotor 100 comprising a rotor core 10, a securing piece 20, a magnet 30, and a rotary shaft 40; the rotor core 10 is provided thereon with a through hole 101 running therethrough, the rotary shaft 40 passes through the through hole 101 and is secured to the rotor core 10, and a plurality of snap-in slots 12 extending through a thickness direction of the rotor core 10 are formed at a peripheral side of the rotor core 10 made of a plurality of silicon steel sheets 11 stacked together. The securing piece 20 comprises a snap portion 21 fitted in the snap-in slot 12 and a securing portion 22 extending along the snap portion 21 and protruding from the outer side surface of the rotor core 10, a tight protrusion-slot fitting is formed between each snap-in slot 12 and one corresponding securing piece 20 so that the securing piece 20 is securely fitted into the snap-in slot 12 of the rotor core 10, which ensures connection reliability between the securing piece 20 and the snap-in slot 12. The magnet 30 is held between the securing portions 22 of two adjacent securing pieces 20; the connection reliability between the snap portion 21 and the snap-in slot 12 may ensure the connection reliability between the magnet 30 and the securing piece 20. The rotor core 10 comprises an upper surface and a lower surface, the upper surface and the lower surface being spaced apart in the thickness direction of the rotor core 10; in addition, the two ends of the securing piece in the thickness direction of the rotor core 10 are flush with the upper surface and the lower surface, respectively. Since the two ends of the securing piece 20 extend towards the two ends of the snap-in slot 12 till an outer portion of the upper surface and an outer portion of the lower surface of the rotor core 10 in the thickness direction of the rotor core 10, the securing piece 20, when being heated, does not impose an axial force against the silicon steel sheets 11 at the two ends of the rotor core 10, so that the silicon steel sheets 11 at the two ends of the rotor core 10 do not get loosened, which enhances secureness and reliability of the rotor core 10 and ensures normal operation of the rotor core 10. In this implementation, since no plastic retainer ring is provided at either end of the rotor core 10, the magnet 30 may be mounted between two adjacent securing pieces 20 from any end of the rotor core 10, whereby mounting flexibility of the magnet 30 is enhanced compared with conventional technologies. In addition, since no retainer ring is provided, axial heat dissipation of the magnet 30 may be enhanced, and thermal capacity of the rotor 100 and the electric motor may also be enhanced.

A person of normal skill in the art may understand that, the implementations described supra are preferred embodiments in implementing the present disclosure; in actual applications, various modifications may be made to the forms and details of the example implementations without departing from the spirits and scope of the present disclosure.

I/We claim:

1. A rotor, comprising:
a rotary shaft;
a rotor core provided thereon with a through hole running therethrough, the rotor core being made of a plurality of silicon steel sheets stacked together, the rotary shaft passing through the through hole and being secured to the rotor core, an outer side surface of the rotor core being inwardly recessed to form a plurality of snap-in slots that are distributed at intervals and extend through a thickness direction of the rotor core;
a securing piece comprising a snap portion fitted in the snap-in slot and a securing portion extending along the snap portion to protrude from the outer side surface of the rotor core, a count of the securing pieces being equal to that of the snap-in slots, the rotor core comprising an upper surface and a lower surface that are oppositely set and spaced apart in the thickness direction, two ends of the securing piece in the thickness direction being flush with the upper surface and the lower surface, respectively;
a magnet held between the securing portions of adjacent two securing pieces.

2. The rotor according to claim 1, wherein the rotor core is made of a plurality of first silicon steel sheets and at least one second silicon steel sheet stacked together, an outer surface of the first silicon steel sheet being inwardly recessed to form a plurality of first notches distributed at intervals, an outer surface of the second silicon steel sheet being inwardly recessed to form a plurality of second notches distributed at intervals, a count of the first notches being equal to that of the second notches, the first notches and the second notches being arranged in one-to-one correspondence to form the snap-in slot, the snap portion being fitted with the first notch in a protrusion-recess manner, the snap portion being fitted with the second notch in a protrusion-recess manner.

3. The rotor according to claim 2, wherein a depth of the first notch is greater than that of the second notch.

4. The rotor according to claim 2, wherein a width of the first notch is greater than that of the second notch.

5. The rotor according to claim 2, wherein the first notch has a bottom end and an opening end which are oppositely set, a width of the bottom end of the first notch being greater than that of the opening end of the first notch.

6. The rotor according to claim 5, wherein the first notch comprises a tapered section and a rectangular section, a width of the tapered section being gradually shrunk in a direction away from a center of the rotor core, one end of the rectangular section distant from the center of the rotor core communicating with one end of the tapered section distant from the center of the rotor core, the end of the rectangular section distant from the center of the rotor core and the end of the tapered section distant from the center of the rotor core extending till an edge of the first silicon steel sheet to form the opening end.

7. The rotor according to claim 2, wherein an outer side surface of the snap portion is inwardly recessed to form a groove, the groove being fitted with one of the at least one second silicon steel sheet in a protrusion-recess manner.

8. The rotor according to claim 7, wherein the groove is formed by an outer side surface of the snap portion inwardly recessed in a direction from the center of the rotor core till an edge of the rotor core; and/or, the groove is formed by the outer side surface of the snap portion inwardly recessed in a circumferential direction of the rotor core.

9. The rotor according to claim 2, wherein the second silicon steel sheet is held between adjacent two of the first silicon steel sheets.

10. An electric motor, comprising the rotor according to claim 1.
